(19) United States
(12) Patent Application Publication
(10) Pub. No.: US 2012/0181125 A1
(43) Pub. Date: Jul. 19, 2012

(54) DECORATIVE KIT FOR VEHICLE BRAKE CALIPERS

(76) Inventor: Jermaine Tamaze Holt, Valley Village, CA (US)

(21) Appl. No.: 13/006,648

(22) Filed: Jan. 14, 2011

(51) Int. Cl. F16D 65/02

(52) U.S. Cl. 188/219.1

(57) ABSTRACT

A decorative element may be applied to a brake caliper to give a customized brake caliper. The decorative elements may have different heights, widths and angles and may be made of heat resistant materials, including, for example, aluminum, plastic, carbon fiber, steel and the like. The present invention also provides a kit, including one or more decorative elements and an attachment means for attaching the decorative elements to the brake caliper (such as glue, two sided adhesive, or the like).

### BACKGROUND OF THE INVENTION

The present invention relates to decorative brake calipers and, more particularly, to geometric elements used to enhance the appearance of a vehicle's brake calipers.

When someone purchases a car with factory brake calipers, the calipers tend to be unattractive and unpleasant to look upon. Typical factory brake calipers do not have the option to choose from a selection of brake caliper accessories to enhance the appearance of the caliper.

As can be seen, there is a need for a brake caliper decorative kit that may allow a user to customize a standard brake caliper.

### SUMMARY OF THE INVENTION

In one aspect of the present invention, a kit for decorating a brake caliper, comprises one or more decorative elements, each decorative element having a flat side and a decorative side; an adhesive for attaching the decorative elements onto the brake caliper.

In another aspect of the present invention, a brake caliper comprises one or more decorative elements secured to the brake caliper, the decorative elements having a flat side and a cylindrical portion rising from the flat side, the cylindrical portion having a diameter from about 0.25 to about 1 inch.

These and other features, aspects and advantages of the present invention will become better understood with reference to the following drawings, description and claims.

### BRIEF DESCRIPTION OF THE DRAWINGS

FIG. 1 is a side view of a brake caliper according to an exemplary embodiment of the present invention, in use;

FIG. 2 is a detail side view of the brake caliper of FIG. 1;

FIG. 3 is a close-up view of a decorative element used on the brake caliper of FIG. 1;

FIG. 4 is a perspective view of a decorative element according to an exemplary embodiment of the present invention;

FIG. 5 is a perspective view of a decorative element according to another exemplary embodiment of the present invention;

FIG. 6 is a back view of a decorative element, depicting a step in applying the decorative element to a brake caliper;

FIG. 7 is a back view of the decorative element of FIG. 6, depicting another step in applying the decorative element to a brake caliper; and

FIG. 8 is a top view of the decorative element applied to the brake caliper.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a decorative element that may be applied to a brake caliper to give a customized brake caliper. The decorative elements may have different heights, widths and angles and may be made of heat resistant materials, including, for example, aluminum, plastic, carbon fiber, steel and the like. The present invention also provides a kit, including one or more decorative elements and an attachment means for attaching the decorative elements to the brake caliper (such as glue, two sided adhesive, or the like).

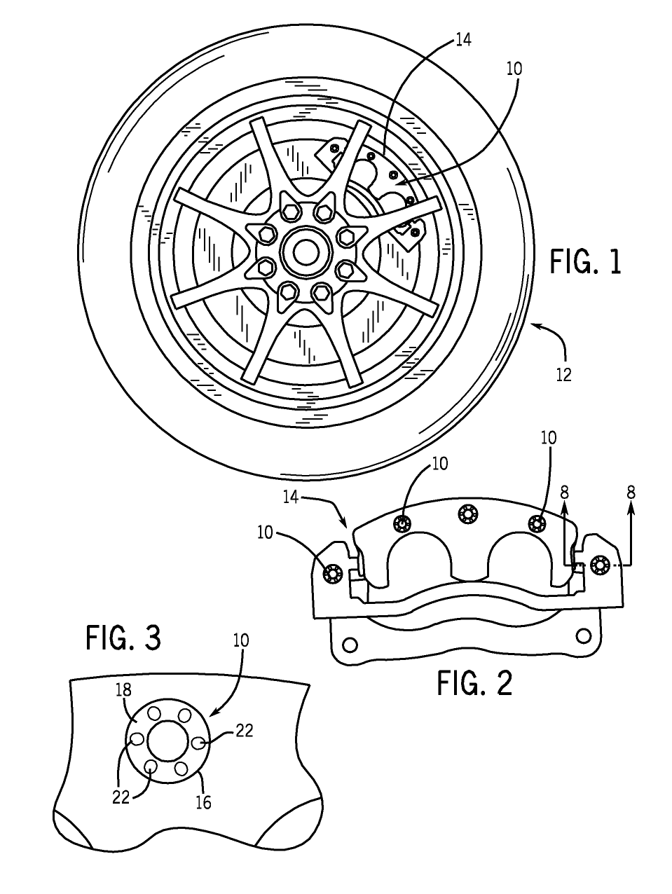

Referring to FIGS. 1 through 4, a brake caliper 14 may be used to slow or stop rotation of a wheel 12 of a vehicle. The brake caliper 14 may include one or more decorative elements 10. The decorative elements 10 may be attached to the brake caliper 14 with any known attachment means, such as glue or two-sided tape, for example. The decorative elements 10 may be made from any heat resistant material, such as plastic, metal, or carbon fibers. The decorative elements 10 may include chrome or a clear coated finish and can include a type of jewelry as an insertion for a unique appearance. Alternatively, the decorative elements 10 may be anodized, In an exemplary embodiment, the decorative elements 10 may be a small computer numerical controlled (CNC) and manufactured metal cap that ranges in size, for example, from about ¼ inch to about 1 inch in diameter and from about 0.1 to about 0.5 inch thick.

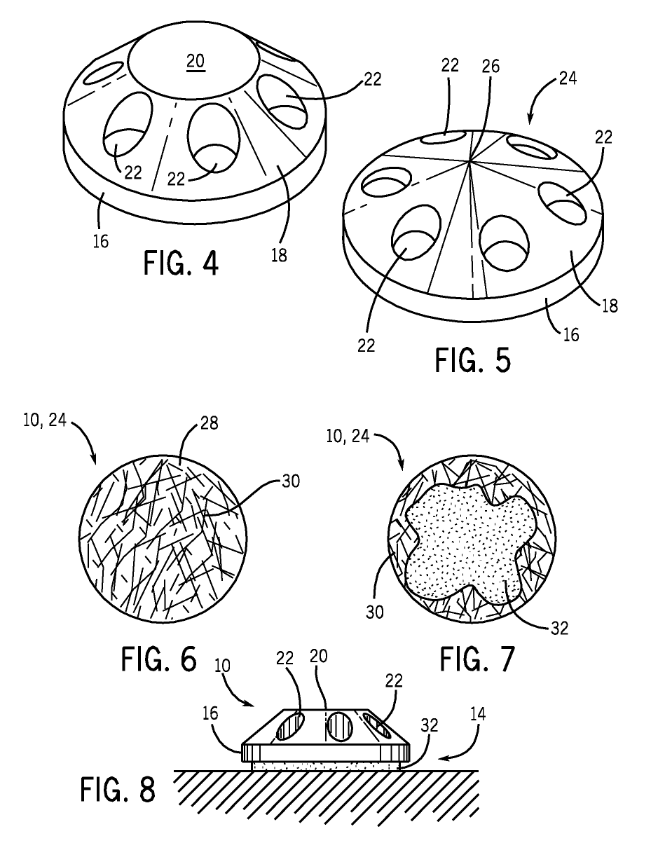

In some embodiments, the decorative elements 10 may include multiple geometrical shapes and sizes for unique designs and appearances. For example, referring to FIGS. 4, 5 and 8, a decorative element 10, 24 may be made in different shapes. The decorative element 10 may include a cylindrical portion 16 and a conical portion 18. A flat portion 20 may also be disposed at the end of the conical portion 18. A plurality of bores may be disposed about the flat portion 20, through the conical portion 18. A mounting surface 28 (see FIG. 6) may be substantially flat to provide a surface for attaching the decorative element 10 to the brake caliper 14. The decorative element 24 (FIG. 5) may omit the flat portion 20 and the conical portion 18 may form an apex 26.

To install the decorative elements 10 onto brake calipers 14, users may remove the wheel 12 from the vehicle, as the wheel may block access to the brake caliper 14. The user may then prepare the brake caliper by cleaning all lose dirt off the brake caliper to make sure it is clean and dry. Users may mark the location s with a pencil or marker where they want to place each decorative element 10 on the brake caliper 14. Users may use a low grit sandpaper to scuff the flat surface of the brake caliper 14 and the back (mounting surface 28) of the decorative element 10. The decorative elements 10 may be placed for example, about 2 inches apart, with an adhesive 32. In some embodiments, the decorative elements 10 may be placed in a pattern on the brake caliper 14. The users may then mount the wheel 12 back onto the vehicle and let the adhesive cure for a recommended amount of time before driving the vehicle.

To make the present invention, a sketch may be created and the sketch may be inputted to a computer. The computer may be programmed by a machinistto operate a CNC or a screw machine. A bar of material, such as billet aluminum or other metals, may be fed forward through a spindle of a CNC or a screw machine. The face of the bar may be machined to a desired pattern and the outside of the bar may be machined to a desired geometrical shape and angle. The bar then may be drilled and cut. The resulting decorative elements may be finished by various means, such as chrome plated.

Alternatively, the decorative elements of the present invention may be manufactured by casting (metal working) using a mold. The casting process may involve pouring liquid metal or plastic into a mold in a desired shape. The mold may be allowed to solidify and the solidified material may be ejected or broken out of the mold. Casting the decorative elements may be useful to make complex shapes that may be difficult or uneconomical to make by other methods.

While the decorative elements described above are useful to decorate brake calipers, they may also be used to decorate other automotive components, such as various areas in the engine bay, the interior or exterior of the vehicle, and the like.

It should be understood, of course, that the foregoing relates to exemplary embodiments of the invention and that modifications may be made without departing from the spirit and scope of the invention as set forth in the following claims.

What is claimed is:

1. A kit for decorating a brake caliper, comprising:
one or more decorative elements, each decorative element having a flat side and a decorative side;
an adhesive for attaching the decorative elements onto the brake caliper.

2. The kit of claim 1, wherein the decorative elements have a cylindrical portion rising from the flat side, the cylindrical portion having a diameter from about 0.25 to about 1 inch.

3. The kit of claim 1, wherein the adhesive is selected from a glue or a two-sided tape.

4. The kit of claim 1, further comprising sandpaper for providing a scuffed mounting surface for the adhesive.

5. The kit of claim 1, wherein the decorative elements are from about 0.1 to about 0.5 inches high.

6. The kit of claim 2, wherein the decorative elements have a conical portion extending from the cylindrical portion.

7. The kit of claim 7, further comprising a plurality of bores through the conical portion.

8. A brake caliper comprising:
one or more decorative elements secured to the brake caliper, the decorative elements having a flat side and a cylindrical portion rising from the flat side, the cylindrical portion having a diameter from about 0.25 to about 1 inch.

9. The brake caliper of claim 8, wherein the decorative elements are made from metal, plastic or a carbon fiber material.

10. The brake caliper of claim 8, wherein:
the decorative elements are from about 0.1 to about 0.5 inches high; and
the decorative ele nts have a conical portion extending from the cylindrical portion.
